(19) United States
(12) Patent Application Publication
(10) Pub. No.: US 2016/0261035 A1
(43) Pub. Date: Sep. 8, 2016

(54) THREE DIMENSIONAL ANTENNA AND FLOATING FENCE

(71) Applicant: NovAtel Inc., Calgary (CA)

(72) Inventor: Ahmad Chamseddine, Calgary (CA)

(73) Assignee: NovAtel, Inc.

(21) Appl. No.: 14/636,272

(22) Filed: Mar. 3, 2015

(51) Int. Cl. H01Q 1/36; H01Q 1/48

(52) U.S. Cl. CPC H01Q 1/36; H01Q 1/48

(57) ABSTRACT

A three-dimensional antenna and a floating fence secondary radiator is provided. The three-dimensional antenna comprises of a plurality of floating curvatures separated by capacitive coupling slots. The floating fence comprises a plurality of metallic elements organized around the primary antenna and configured to serve as a secondary radiator to provide beam shaping.

### BACKGROUND OF THE INVENTION

1. Field of the Invention

The present invention is directed to GNSS antennas, more particularly to three-s dimensional antennas for GNSS use, as a reference antenna and/or in a rover application.

2. Background Information

Antennas directed to GNSS applications are subject to specific requirements that must be met to allow the end-user to benefit from weak satellite signals. GNSS applications require continuous signal tracking of any satellites in the upper hemisphere of the user. This tracking requirement imposes a series of design constraints for the antenna, namely radiation pattern roll off, multipath rejection, axial ratio and phase center stability for any satellites seen by the antenna above the hemisphere.

FIG. 1 is a perspective view of an exemplary prior art choke ring antenna 100 as is commonly used for GNSS applications. The choke ring antenna 100 illustratively comprises a central dome 105 and a plurality of concentric rings 110A-D comprising a ground plane. The central dome 105 houses the active elements of the antenna 100. Choke ring antennas are commonly used for high end reference stations due to their proven phase center stability and low susceptibility to multi pass interference.

In a conventional choke ring antenna, the concentric rings 110 are typically slightly more than one quarter of the GPS's L2 wavelength deep and are designed to eliminate reflected signals, thereby preventing the propagation of surface waves near the antenna. A noted disadvantage of traditional choke ring antennas is their poor reception and tracking of satellites near the horizon. Further, choke ring antennas suffer from weak multipath rejection at some GNSS frequency points. In modern GNSS applications, signals from low elevations headlights may be very important to aid in the correlation of station height and tropospheric parameters.

FIG. 2A is a perspective view of a an exemplary prior art choke ring antenna 200 as is used in GNSS applications. The choke ring antenna 200 illustratively comprises a central dome 105 and a plurality of concentric rings 205A-D. As noted above, the central dome 105 illustratively houses the radiating elements of the antenna 200A. The s concentric rings 205 are illustratively arranged so that each ring sits lower than the previous ring. The choke ring antenna thus forms a conical shape when viewed from the side as shown by antenna 200B in FIG. 2B. Exemplary prior art antennas, such as those shown in FIGS. 1, 2A and 2B typically have weak tracking capabilities for new GNSS constellations, such as Glonass and Beidou. These weak tracking capabilities limit their usefulness in certain GNSS applications.

### SUMMARY OF THE INVENTION

A three dimensional antenna is provided that has excellent tracking of satellites as well as multipath rejection across the entire GNSS bands. The three dimensional antenna illustratively comprises of four floating curvatures that are separated by one or more is capacitive coupling slots. The curvatures may be of any geometry and are organized to be electrically separated from a ground plane. Further, a floating fence of metallic shapes may be illustratively used as a secondary radiator with a radiating antenna in accordance with alternative embodiments of the present invention. The floating fence illustratively comprises a plurality of metallic elements that may be organized, e.g., as dipoles organized around the primary antenna. The well determined coupling between the primary antenna and the floating fence illustratively provides beam shaping and improved antenna properties.

### BRIEF DESCRIPTION OF THE DRAWINGS

The above and further advantages of the invention are described below in reference to the following figures, in which like reference numerals indicate identical or functionally similar items, of which:

FIG. 1, previously described, is a perspective view of a prior art choke ring antenna;

FIG. 2A, previous described, is a perspective view of a prior art choke ring antenna;

FIG. 2B, previously described, is a side view of a prior art choke ring antenna;

FIG. 3 is a perspective view of an exemplary three dimensional GNSS antenna in accordance with an illustrative embodiment of the present invention;

FIG. 4 is a perspective view of an exemplary floating fence in accordance with an illustrative embodiment of the present invention;

FIG. 5 is a perspective view of an exemplary floating fence having trapezoidal floating structures in accordance with an illustrative embodiment of the present invention;

FIG. 6 is a perspective view of an exemplary three-dimensional antenna in accordance with an illustrative embodiment of the present invention;

FIG. 7 is a perspective view of an exemplary three-dimensional antenna in accordance with an illustrative embodiment of the present invention;

FIG. 8 is a perspective view of an exemplary three-dimensional antenna in accordance with an illustrative embodiment of the present invention;

FIG. 9 is a chart illustrating measured data of an exemplary three dimensional antenna in a near field range in accordance with an illustrative embodiment of the present invention;

FIG. 10A is an exemplary polar plot of the UUT upper band radiation pattern in accordance with an illustrative embodiment of the present invention;

FIG. 10B is an exemplary polar plot of the UUT upper band radiation pattern in accordance with an illustrative embodiment of the present invention; and

FIG. 11 is a chart illustrating the phase center offset in accordance with an illustrative embodiment of the present invention.

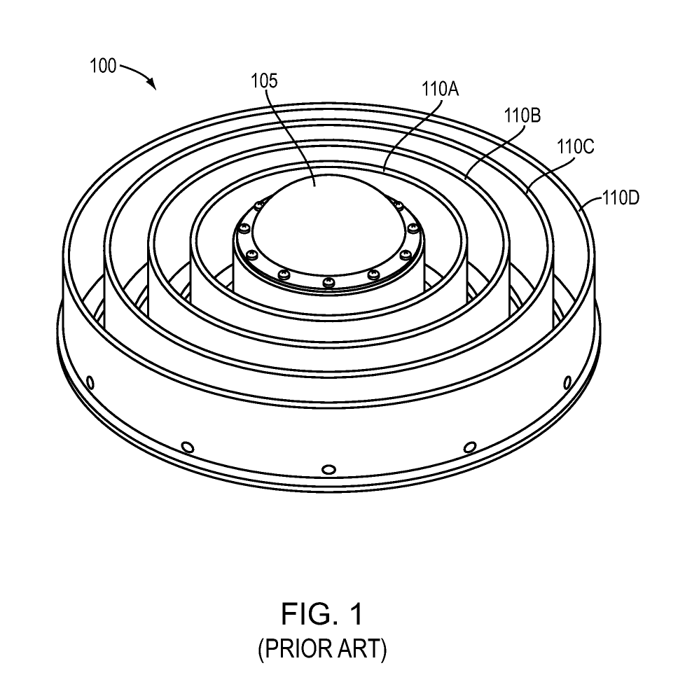

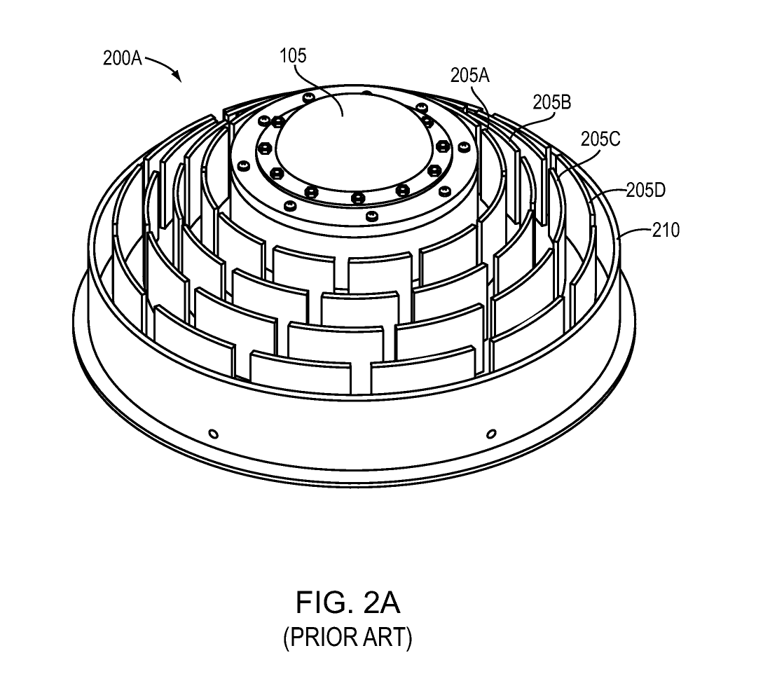

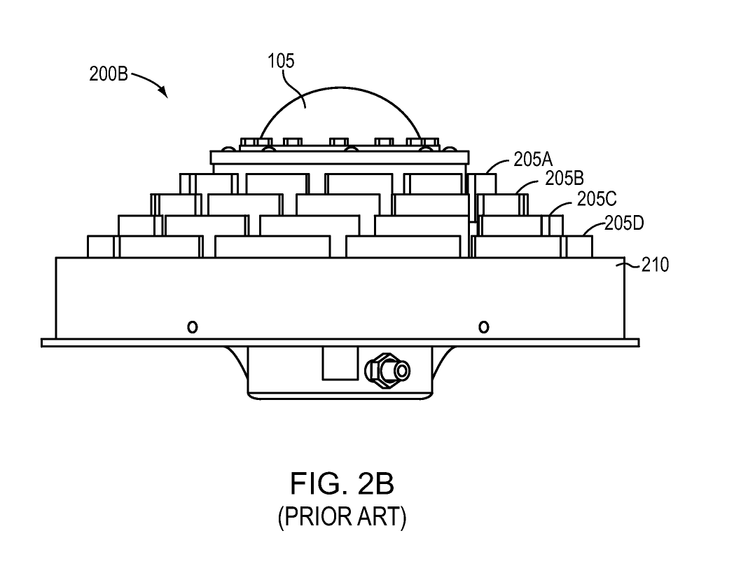

### DETAILED DESCRIPTION OF AN ILLUSTRATIVE EMBODIMENT

As noted above, antennas dedicated to GNSS applications are subject to specific requirements that must be met to allow the end-user to benefit from the satellite signals. GNSS applications require continuous signal tracking of any satellites in the upper hemisphere of any user. This requirement imposes a series of design constraints on the antennas, e.g., radiation pattern rolloff, multipath rejection, axial ratio and face center stability. With the addition of new GNSS constellations such as Beidou and Galileo, the need for GNSS antennas that provide appropriate coverage has increased. Embodiments of the present invention are directed to ensuring that appropriate coverage is obtained.

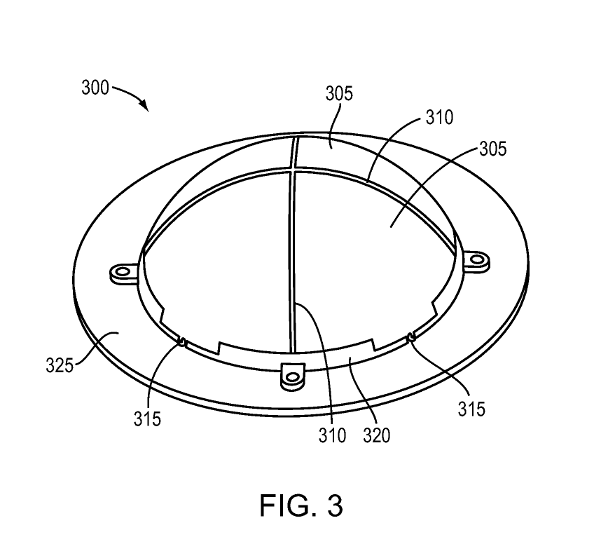

FIG. 3 is a perspective view of an exemplary three-dimensional antenna 300 in accordance with an illustrative embodiment of the present invention. The antenna 300 illustratively comprises of four floating curvatures 305 separated by capacitive coupling slots 310. Each of the floating curvatures 305 includes an antenna feed point 315 that is is illustratively located at a midpoint of the bottom of the floating curvature network and receives signals from a feeding network (not shown). In illustrative embodiments of the present invention, the feed network generates signals with equal amplitude and phase quadratures to generate a right-hand circularly (RHC) polarized signal. Illustratively, the floating curvatures 305 are operatively mounted to a ground 325.

Floating curvatures 305 are illustratively substantially hemispherical; however, it should be noted that the curvatures are not required to be hemispherical. In alternative embodiments, the four curvatures may be of any shape including, e.g., square, triangular, parabolic, etc. In the illustrative embodiment shown in FIG. 3, the substantially hemispherical shape is utilized to radiate with a minimum signal roll off at the horizon. This minimization of signal roll off is important to maintain tracking of GNSS satellites at low elevations. Further, signal falloff minimization is important in the case of agricultural precision applications in GNSS. Each of the floating curvatures 305 is electrically separated from each other by a capacitive coupling slot 310 to ensure the needed capacitive coupling to increase the efficiency of the antenna. Illustratively, the capacitive coupling has a direct impact on the multipath and signal gain at the lower bands, e.g., L5 and L2.

Illustratively, the floating curvatures are placed above the ground plane at 325 at a predefined distance. The spacing may have a direct effect on improving the multipath rejection and antenna gain of all GNSS bands of exemplary antenna 300. Illustratively, cuts 320 are introduced to the bottom side of each floating curvature 305 to improve the impedance matching of the antenna without affecting the radiation pattern. It should be noted that in alternative embodiments, the number and placement of cuts may vary. Further, in alternative embodiments, the floating curvature may not have the cuts described herein. As such, the description of cuts should be taken as exemplary only.

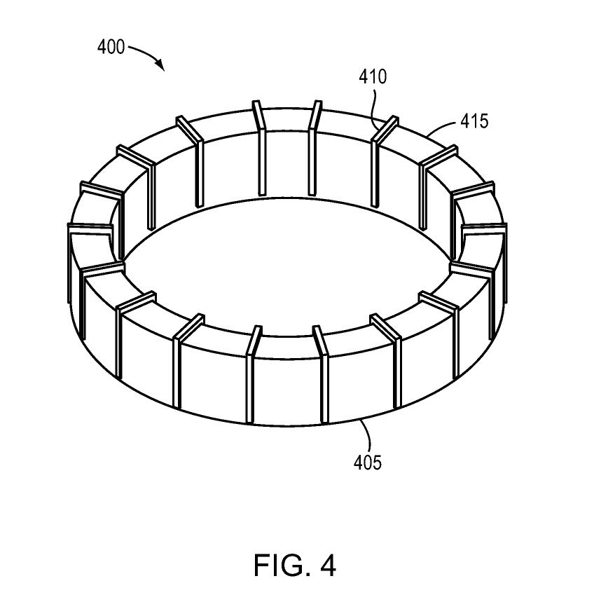

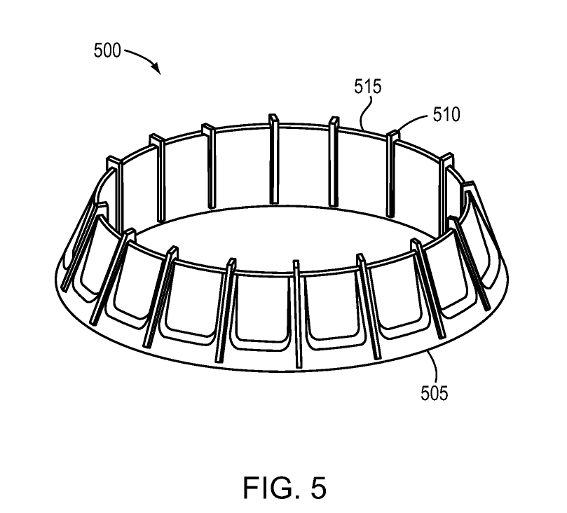

Exemplary antenna 300 provides appropriate coverage for GNSS applications. As will be appreciated by those skilled in the art, the antenna 300 may be sized based on desired wavelengths to be covered by the antenna. The antenna may be used as an antenna for GNSS uses as a single radiator or may, in accordance with alternative embodiments, use a secondary radiator, such as that described below in reference to FIGS. 4 and 5.

FIG. 4 is a perspective diagram of an exemplary floating radiating fence 400 in accordance with an illustrative embodiment of the present invention. The fence 400, or parasitic array, illustratively comprises of a plurality of floating metal elements 410 separated by plastic holders 415. The metallic elements 410 are illustratively made of a material that will aid in electromagnetic coupling of a primary radiating antenna located inside of the fence. The plastic holders 415 are described as being made of plastic, but in alternative embodiments, may be made of any non-conductive material. As such, the description of holders 415 being made of plastic should be taken as exemplary only.

The metallic elements illustratively serve as a secondary radiator for a primary antenna. Illustratively, the fence is distributed around any type of antenna located within the void in the center of the floating fence. Illustratively, the floating metal elements are illustratively organize as a plurality of dipole antennas. The fence 400 reshapes the radiation pattern of the antenna located within the fence by coupling with the main antenna elements and acts as a beam shaper providing a much cleaner radiation pattern and therefore improved antenna properties. Illustratively, the number and dimensions of the dipoles embodied as a floating metal elements as well as the clearance from the ground plane 405 are design sensitive parameters and may be optimized to improve the low elevation tracking, axial ratio and multipath rejection of the antenna.

Illustratively, the dipoles are dimensioned to be wideband to cover all GNSS frequency bands. In accordance with alternative embodiments of the present invention, the number of dipoles may vary to be adjusted to meet design specifications. Further, in alternative embodiments, the dipoles may be three dimensioned to target different frequencies. Thus, the number and shape of the metallic elements 410 should be taken as exemplary only. While floating fence 400 is shown to be circular in nature, in accordance with alternative embodiments of the present invention, the fencing structure may be square, triangular or any other geometric shape needed to surround a primary antenna.

FIG. 5 is a perspective view of an exemplary floating fence 500 in accordance with an illustrative embodiment of the present invention. Floating fence 500 illustrates an alternative design pattern in that the metallic elements 510 are not rectangular as they are depicted in FIG. 4. Instead, the metallic elements 510 have a trapezoidal cross-section. As will be appreciated by those skilled in the art, changes in the metallic elements' shapes may vary based on a user's design choices. Thus, the description in relation to the floating fence 400 of FIG. 4 and floating fence 500 of FIG. 5 should be taken as exemplary embodiments. The principles of the inventive concepts described herein may utilize any of a variety of shapes for metallic elements of a floating fence in accordance with alternative embodiments. Thus, the description of rectangular and/or trapezoidal metallic elements should be taken as exemplary only.

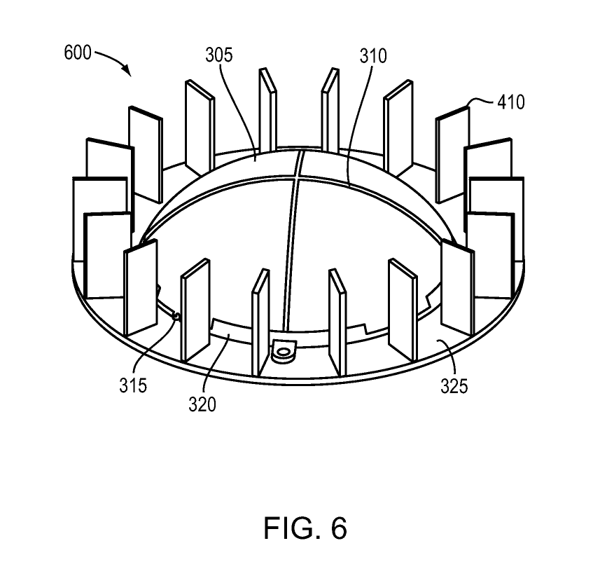

FIG. 6 is a perspective view of an exemplary three-dimensional antenna 600 incorporating a floating radiating fence in accordance with an illustrative embodiment of the present invention. Exemplary antenna 600 incorporates the three-dimensional antenna described above in relation to FIG. 3 as well as the concept of the floating fence discussed above in relation to FIGS. 4 and 5. In this example, the primary antenna comprises the three-dimensional antenna 300, while the floating fence 400 serves as a secondary radiator that provides beam shaping and other advantages. Exemplary antenna 600 comprises of four curvatures 305 electrically separated by capacitive coupling slots 310. A plurality of metallic elements 410 are organized as a floating fence. It should be noted that in FIG. 6, the non-metallic holding elements 405 are not shown for illustrative purposes.

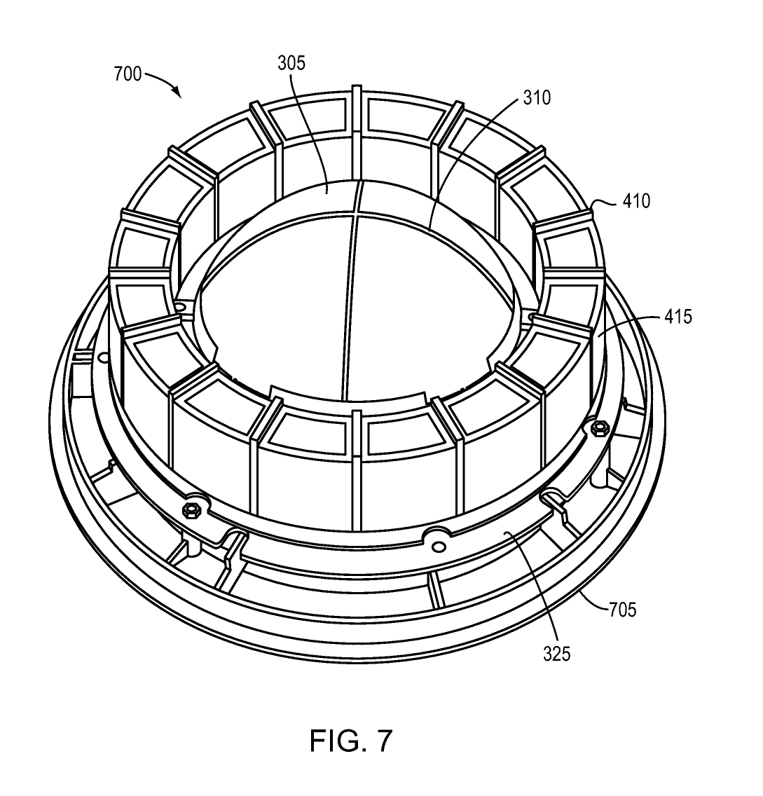

FIG. 7 is a perspective view of an exemplary three-dimensional antenna 700 surrounded by a floating fence assembly in accordance with an illustrative embodiment of the present invention. Exemplary antenna 700 is similar to antenna 600 described above in relation to FIG. 6; however, in FIG. 7, the non-metallic holding elements 415 are displayed. Further, an exemplary base 705 is shown upon which the antenna 700 is mounted. The base 705 may be used to support the antenna 700 when mounted in an application setting, e.g., when being used for GNSS purposes in the field.

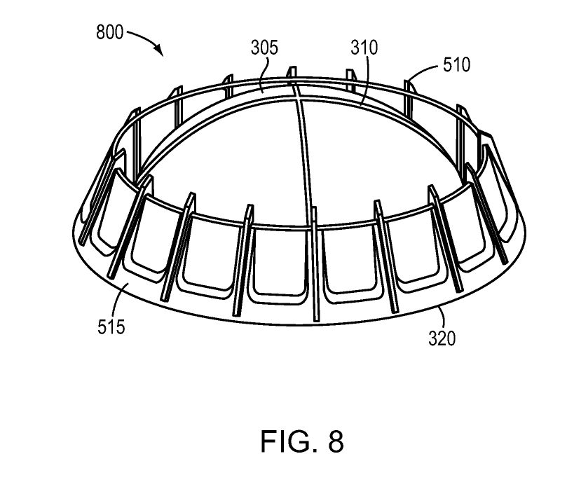

FIG. 8 is a perspective view of an exemplary three-dimensional antenna 800 surrounded by a floating fence in accordance with an illustrative embodiment of the is present invention. The antenna 800 is similar to antenna 600 described above in relation to FIG. 6; however, trapezoidal metallic elements 510 (FIG. 5) are utilized for the floating fence instead of the rectangular metallic elements 410 used in FIG. 4.

As will be appreciated from the above description, embodiments of the present invention may comprise a three dimensional antenna 300, a floating fence 400, 500 or a combination thereof. Thus, in an illustrative embodiment, the three dimensional antenna 300 may be used without a floating fence 400, 500. Similarly, in an alternative embodiment, a floating fence 400, 500 may be utilized with a primary radiating antenna other than three dimensional antenna 300.

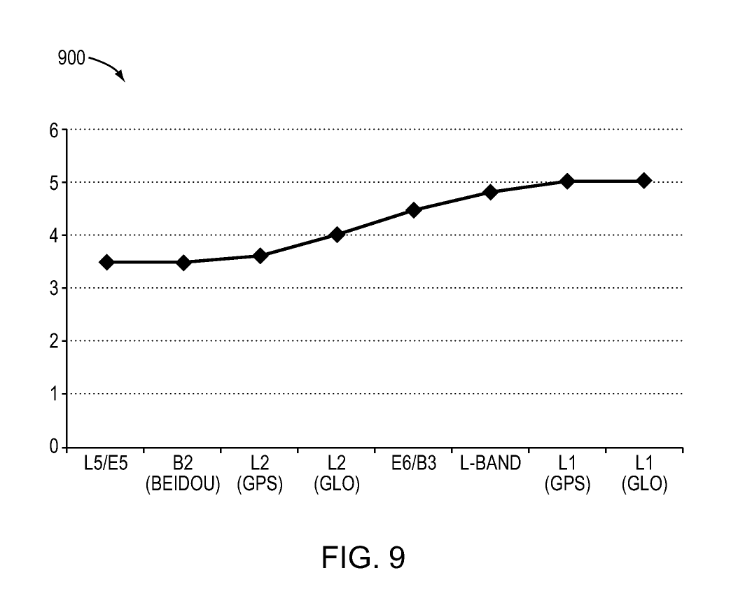

FIG. 9 is an exemplary chart 900 illustrating measured data from an exemplary three dimensional antenna in accordance with an illustrative embodiment of the present invention. As can be seen from chart 900, the range is from approximately 3.5 in the lower bands (L5 and Beidou) up to approximately 5 in L1.

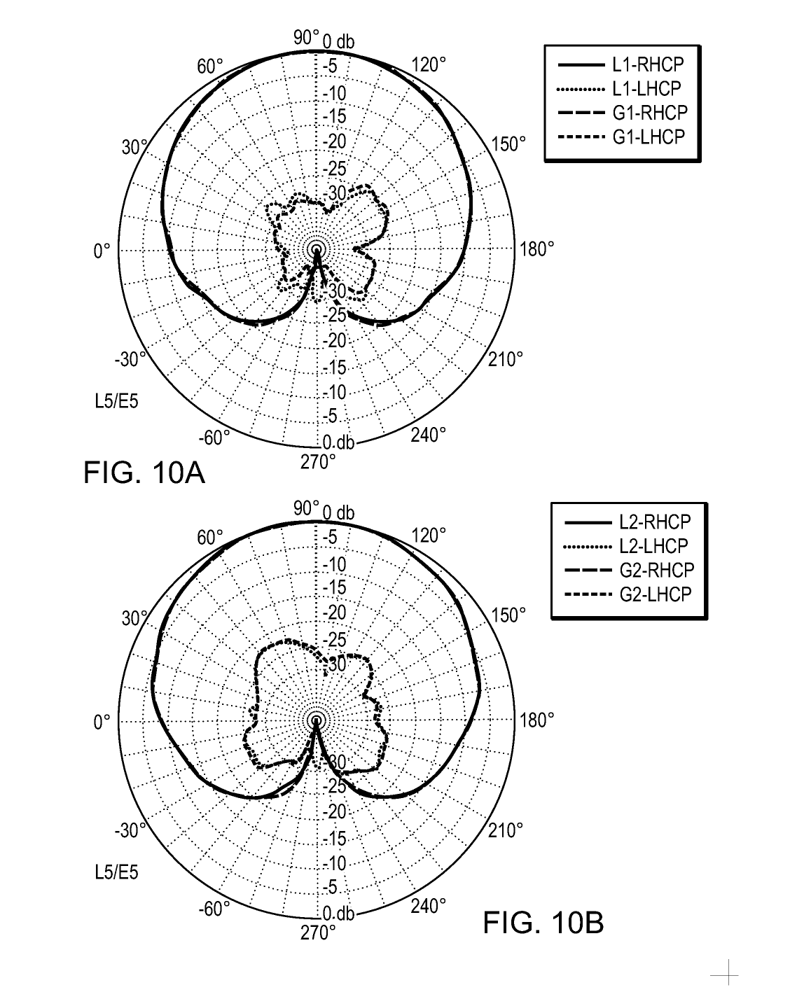

FIGS. 10A and 10B are exemplary polar plots of the three dimensional antenna in accordance with an illustrative embodiment of the present invention. FIG. 10A is a chart illustration the UUT upper band radiation pattern. Similarly, FIG. 10B is a chart illustrating the UUT lower band radiation pattern in accordance with an illustrative embodiment.

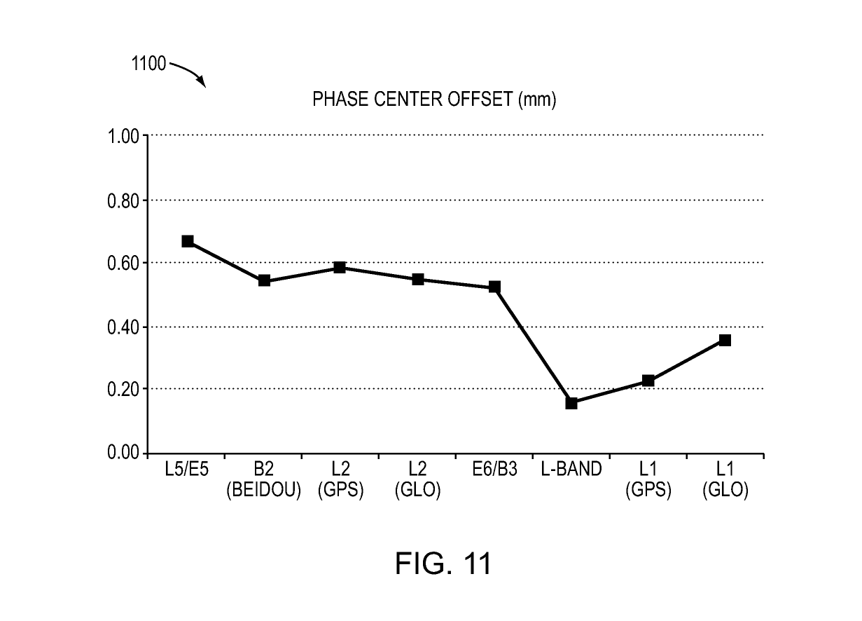

FIG. 11 is an exemplary chart of the phase center offset observed using a three dimensional antenna in accordance with an illustrative embodiment of the present invention. As can be seen from the chart 1100, the phase center offset is below 1 mm across the L5-L1 bands.

The foregoing description has been directed to specific embodiments. It will be apparent, however, that other variations and/or modifications may be made to the described embodiments, the attainment of some or all of their advantages. Accordingly, this description is be taken by way of example only and not to otherwise limit the scope of the invention. Therefore, it is the object of the appended claims to cover all such variations and modifications within the true spirit and scope of the invention.

What is claimed is:

1. An antenna comprising:
a set of curvatures arranged to form a first three-dimensional shape;
a set of capacitive coupling slots arranged between the set of curvatures; and
a ground plane.

2. The antenna of claim 1 wherein the first three-dimensional shape comprises a substantially hemispherical shape.

3. The antenna of claim 1 wherein the set of curvatures comprises four curvatures.

4. The antenna of claim 1 wherein the set of curvatures are located a predefined distance from the ground plane.

5. The antenna of claim 1 wherein each of the set of curvatures further comprises a feed point.

6. The antenna of claim 5 wherein the feed points are located at an approximate midpoint of each curvature.

7. The antenna of claim 1 wherein each of the set of curvatures further comprises one or more cutouts.

8. The antenna of claim 1 further comprising a floating fence encircling the set of floating curvatures, wherein the floating fence comprises:
a plurality of metallic elements arranged in a second three-dimensional shape; and
a plurality of non-conductive spacing elements configured to support the set of radiating elements.

9. The antenna of claim 8 wherein the second three-dimensional shape comprises a ring shape.

10. The antenna of claim 8 wherein the metallic elements have a substantially rectangular shape.

11. The antenna of claim 8 wherein the floating fence is electrically separated from the ground plane.

12. The antenna of claim 8 wherein the metallic elements have a substantially trapezoidal shape.

13. The antenna of claim 1 wherein the set of curvatures are sized based on a set of desired wavelengths for the antenna.

14. A parasitic array comprising:
a plurality of metallic elements arranged in a first three-dimensional shape; and
a plurality of non-conductive spacing elements configured to support the set of radiating elements; and
s a primary radiator located substantially centered in the first three-dimensional shape.

15. The parasitic array of claim 14 wherein the first three-dimensional shape comprises a ring.

16. The parasitic array of claim 4 wherein the metallic elements are substantially trapezoidal in shape.

17. The parasitic array of claim 14 wherein the primary radiator further comprises:
a set of curvatures arranged to form a second three-dimensional shape;
a set of capacitive coupling slots arranged between the set of curvatures; and
a ground plane.
